(19) United States
(12) Patent Application Publication
(10) Pub. No.: US 2015/0235061 A1
(43) Pub. Date: Aug. 20, 2015

(54) TAG READING APPARATUS AND METHOD, TAG IDENTIFICATION SYSTEM

(71) Applicant: I-PATROL TECHNOLOGY LIMITED, Hong Kong (CN)

(72) Inventors: Yi WANG, Hong Kong (CN); Ching Lap Chan, Hong Kong (CN)

(73) Assignee: I-PATROL TECHNOLOGY LIMITED

(21) Appl. No.: 14/705,196

(22) Filed: May 6, 2015

Related U.S. Application Data
(63) Continuation of application No. PCT/CN2013/073038, filed on Mar. 22, 2013.

(30) Foreign Application Priority Data
Feb. 4, 2013 (CN) 201310043879.3

(51) Int. Cl. G06K 7/10; G06F 17/30

(52) U.S. Cl. CPC G06K 7/10009; G06F 17/30038

(57) ABSTRACT

An apparatus for reading a tag, includes: a reading module for reading first tag information from the tag; a digital logic control module coupled to the reading module, the digital logic control module including a preset digital logic circuit for performing a logical operation on the first tag information to obtain second tag information, the second tag information including real information of the tag; and an output module coupled to the digital logic control module for outputting the second tag information.

### CROSS REFERENCE TO RELATED APPLICATIONS

The present application is a continuation of International Application No. PCT/CN2013/073038, filed Mar. 22, 2013, which is based upon and claims priority to Chinese Patent Application No. 201310043879.3, filed Feb. 4, 2013, the entire contents of all of which are incorporated herein by reference.

### TECHNICAL FIELD

The present disclosure generally relates to the technical field of Internet of Things (IoT) and, more particularly, to a tag reading apparatus and method, and a tag identification system.

### BACKGROUND

Internet of Things (IoT) refers to uniquely identifiable objects and their virtual representations in an Internet-like structure. Conventionally, tag identification technologies have been applied in logistics, anti-counterfeiting, and other fields of the IoT. For example, radio-frequency identification (RFID) technology is used for the contactless identification of tag information. An RFID reader can perform contactless, bidirectional data communication with a radio frequency (RF) tag to identify the RF tag. However, as the tag identification technologies generally use wireless communication channels, unauthorized users can intercept communication data and even counterfeit tag reading apparatuses to read tag information, which increases security risks.

### SUMMARY

According to a first aspect of the present disclosure, there is provided an apparatus for reading a tag, comprising: a reading module for reading first tag information from the tag; a digital logic control module coupled to the reading module, the digital logic control module including a preset digital logic circuit for performing a logical operation on the first tag information to obtain second tag information, the second tag information including real information of the tag; and an output module coupled to the digital logic control module for outputting the second tag information.

According to a second aspect of the present disclosure, there is provided a tag identification system, comprising: a tag including first tag information, the first tag information being generated by a first digital logic circuit; and a tag reading apparatus, wherein the tag reading apparatus includes: a reading module for reading the first tag information from the tag; a digital logic control module coupled to the reading module, the digital logic control module including a preset digital logic circuit matching the first digital logic circuit for performing a logical operation on the first tag information, to obtain second tag information, the second tag information including real information of the tag; and an output module coupled to the digital logic control module for outputting the second tag information.

According to a third aspect of the present disclosure, there is provided a method for a device to read a tag, comprising: reading first tag information from the tag; performing, by a preset digital logic circuit in the device, a logical operation on the first tag information to obtain second tag information, the second tag information including real information of the tag; and outputting the second tag information.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIGS. 1-4 are block diagrams of tag reading apparatuses, according to exemplary embodiments.

FIG. 5 is a block diagram of a tag identification system, according to an exemplary embodiment.

FIG. 6 is a flowchart of a tag reading method, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

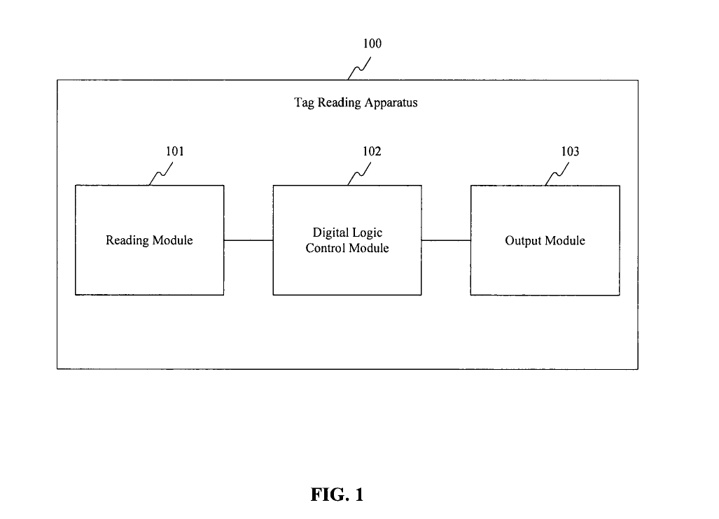

FIG. 1 is a block diagram of a tag reading apparatus 100, according to an exemplary embodiment. Referring to FIG. 1, the tag reading apparatus 100 includes a reading module 101, a digital logic control module 102, and an output module 103.

In exemplary embodiments, the reading module 101 is configured to read first tag information from a tag. For example, the reading module 101 may be a circuit or a chip configured to read the first tag information based on a radio-frequency identification technology, a near field communication (NFC) technology, a Bluetooth technology, a Wi-Fi technology, an infrared technology, a Zigbee communication technology, an audio/ultrasonic technology, a visual technology (e.g., an image pattern recognition technology), etc. Also for example, the reading module 101 includes an antenna and is configured to read the first tag information from the tag by the antenna.

The digital logic control module 102 is connected with the reading module 101, and includes a preset digital logic circuit (not shown). The digital logic control module 102 is configured to obtain second tag information by performing, using the preset digital logic circuit, a logical operation on the first tag information received from the reading module 101, the second tag information being real information of the tag. The output module 103 is connected with the digital logic control module 102, and is configured to output the second tag information.

In exemplary embodiments, the first tag information in the tag is generated by, among other things, a digital logic circuit that matches the preset digital logic circuit in the digital logic control module 102. For example, the digital logic circuit generating the first tag information is configured to perform a logical operation related to, e.g., the same as, the logical operation performed the preset digital logic circuit in the digital logic control module 102. As such, the first tag information is encrypted tag information, and the digital logic control module 102 can perform the related logical operation to decrypt the encrypted tag information. In the illustrated embodiment, the first tag information is converted to the second tag information after being processed by the digital logic circuit in the digital logic control module 102. Unless the tag is a counterfeit tag, the second tag information is the actual data of the tag.

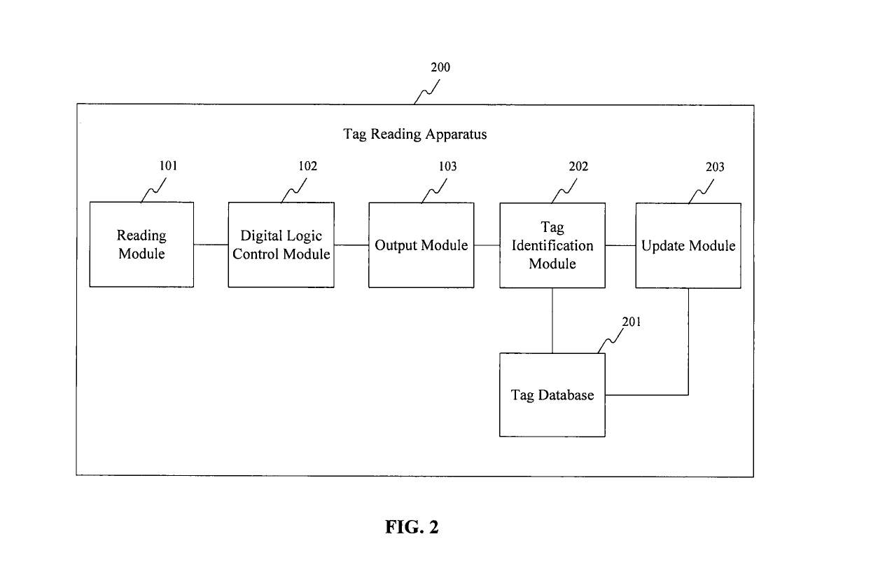

FIG. 2 is a block diagram of a tag reading apparatus 200, according to an exemplary embodiment. Referring to FIG. 2, the tag reading apparatus 200 includes a tag database 201, a tag identification module 202, and an update module 203, in addition to the reading module 101, the digital logic control module 102, and the output module 103 (FIG. 1).

In exemplary embodiments, the tag database 201 stores tag information that can be identified by the tag reading apparatus 200. The tag identification module 202 is configured to identify the second tag information output by the output module 103 in the tag database 201. For example, if the second tag information is stored in the tag database 201, the tag identification module 202 determines that the tag is a real tag by identifying the second tag information. Furthermore, the tag identification module 202 is also configured to obtain item information regarding an item to which the tag is attached, including a state and other data of the item, based on the second tag information.

In addition, the tag database 201 also stores a plurality of state response values of a plurality of tags, such as N tags, respectively. The update module 203 is configured to update, when the tag identification module 202 identifies the second tag information in the database 201 and the state response value of the tag having the second tag information is stored in the database 201, the state response value of the tag according to a current state of the item corresponding to the tag. In the illustrated embodiment, the state response value corresponds to the state of the item. For example, the state response value indicates the state of the item corresponding to the tag, such as item arrival, item removal, item sold, present item location, etc.

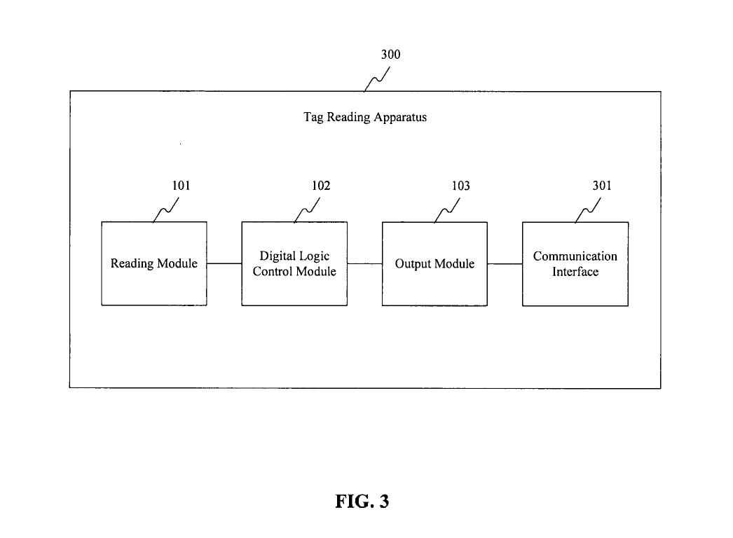

In exemplary embodiments, a database of stored tag information is configured in user equipment (UE) or integrated into a third party application (APP), in order to reduce cost of the tag reading apparatus. For example, the database of stored tag information can be installed in the UE by downloading and installing the APP in the UE. FIG. 3 is a block diagram of a tag reading apparatus 300 for use with the UE, according to an exemplary embodiment. Referring to FIG. 3, the tag reading apparatus 300 includes a communication interface 301, in addition to the reading module 101, the digital logic control module 102, and the output module 103 (FIG. 1).

In exemplary embodiments, the communication interface 301 is configured to connect with the UE. For example. the output module 103 outputs the second tag information to the UE through the communication interface 301 to identify the second tag information in the database of the UE. In some embodiments, the database of stored tag information is located in a remote central server. Accordingly, the tag reading apparatus 300 is configured to identify the second tag information through the UE communicating with the remote central server by the communication interface 301 and an APP installed on the UE. Moreover, the communication interface 301 can be connected to a headphone jack in the UE. Accordingly, the tag reading apparatus 300 may realize data communication through the communication interface 301 and the headphone jack of the UE. In addition, the communication interface 301 can also be a data interface, such as a universal serial bus (USB) interface, or a wireless communication interface, such as Bluetooth, infrared, Wi-Fi, etc.

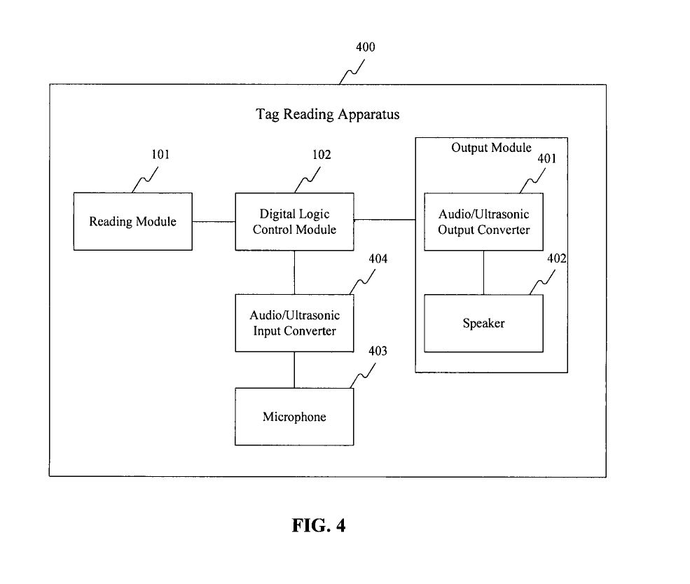

FIG. 4 is a block diagram of a tag reading apparatus 400, according to an exemplary embodiment. Referring to FIG. 4, the tag reading apparatus 400 includes the output module 103 (FIG. 1) that further includes an audio/ultrasonic output converter 401 and a speaker 402, a microphone 403, an audio/ultrasonic wave input converter 404, in addition to the reading module 101 and the digital logic control module 102 (FIG. 1).

In exemplary embodiments, the audio/ultrasonic output converter 401 is configured to convert the second tag information into an audio/ultrasonic signal. The speaker 402 is configured to output the audio/ultrasonic signal for the UE to receive and convert the audio/ultrasonic signal back to the second tag information, and to identify the second tag information, e.g., in a database of the UE. In the illustrated embodiment, the tag reading apparatus 400 is configured to realize bidirectional communications with the UE in an audio/ultrasonic way. For example, the microphone 403 is configured to receive an audio/ultrasonic signal from the UE, and the audio/ultrasonic input converter 404 is configured to convert the audio/ultrasonic signal received from the UE into a digital signal for the tag reading apparatus 400 to process. In another embodiment, the tag reading apparatus 400 and the UE communicate based on an image pattern recognition technology. In some embodiments, the digital signal includes encrypted data. Accordingly, the digital logic control module 102 can be connected with the audio/ultrasonic input converter 404 to decrypt the encrypted data using the preset digital logic circuit, thereby obtaining decrypted data from the digital signal.

In exemplary embodiments, the tag reading apparatus 300 (FIG. 3) or 400 (FIG. 3) also includes an update module (not shown). In one exemplary embodiment, a database of stored tag information is located in the UE. Accordingly, the update module updates a state response value corresponding to the tag when the second tag information is identified on the UE and the state response value corresponding to the tag is stored in the UE. In one exemplary embodiment, the database of stored tag information is located in the remote central server. Accordingly, the update module is configured to update the state response value corresponding to the tag through the UE communicating with the remote central server, when the second tag information is identified in the remote central server, according to a current state of the item corresponding to the second tag information. For example, the state response value indicates a state of the item to which the tag attaches, such as item arrival, item removal, item sold, present item location, etc.

In exemplary embodiments, any of the above described tag reading apparatuses can include a pairing interface for connecting the tag reading apparatus with a paired device to realize data sharing after a successful connection is made between the pairing interface and the paired device. In one exemplary embodiment, the paired device includes a digital logic control module that matches the digital logic control module in the tag reading apparatus. For example, the digital logic control module in the paired device is configured to perform a logical operation related to the logical operation performed by the digital logic control module in the tag reading apparatus. As such, when the tag reading apparatus reads data from the paired device, which is encrypted by the digital logic control module in the paired device, the digital logic control module in the tag reading apparatus can perform a related logical operation to decrypt the encrypted data. Also for example, the paired device may be another tag reading apparatus or a carrier with a digital logic control module, such as a USB storage device, a hard drive, etc.

In exemplary embodiments, the tag reading apparatus can be implemented as a radio-frequency identification (RFID) reader, a near field communication (NFC) reader, a Bluetooth reader, a Wi-Fi reader, an infrared reader, a Zigbee reader, an audio/ultrasonic signal transceiver, a visual signal transceiver, etc. The types of tags to be read are different for different types of tag readers. For example, an RFID tag is read by an RFID reader, an NFC tag is read by an NFC reader, a Bluetooth tag is read by a Bluetooth reader, a Wi-Fi tag is read by a Wi-Fi reader, an infrared tag is read by an infrared reader, and a Zigbee tag is read by a Zigbee reader. The ultrasonic transceiver can read tags that have the function of converting tag information into an ultrasonic signal.

In the above illustrated embodiments, the tag reading apparatus includes a digital logic control module configured to perform a logical operation on tag information read by the preset digital logic circuit. Because different digital logic circuits will generate different results from the same data due to performing different logical operations, only the preset digital logic circuit of the tag reading apparatus can obtain the real tag information. As a result, an unauthorized user will not obtain the real tag information, even after intercepting data communicated between the tag reading apparatus and the tag. The unauthorized user will also not obtain the real tag information by counterfeiting a tag reading apparatus.

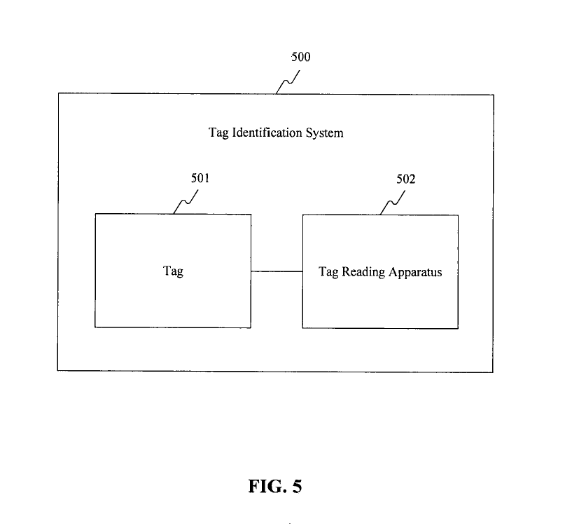

FIG. 5 is a block diagram of a tag identification system 500, according to an exemplary embodiment. Referring to FIG. 5, the tag identification system 500 includes a tag 501 and a tag reading apparatus 502.

In exemplary embodiments, the tag 501 is a tag that is capable of being identified by the tag reading apparatus 502. The tag reading apparatus 502 can read one or multiple tags 501. The tag identification system 500 can include one or multiple tag reading apparatuses 502. There is no limitation on the number of the tags 501 and the number of the tag reading apparatuses 502 in the tag identification system 500. The tag reading apparatus 502 can be any of the above described tag reading apparatuses.

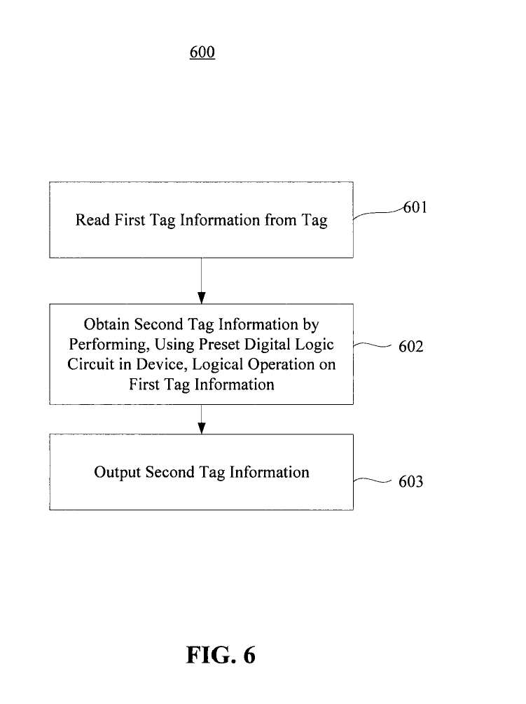

FIG. 6 is a flowchart of a tag reading method 600 for use in a device, according to an exemplary embodiment. For example, the device can be any of the above described tag reading apparatus. Refer to FIG. 6, the tag reading method 600 includes the following steps.

In step 601, the device reads first tag information from a tag. For example, the device is configured to read the first tag information based on a radio-frequency identification technology, a near field communication (NFC) technology, a Bluetooth technology, a Wi-Fi technology, an infrared technology, a Zigbee communication technology, an audio/ultrasonic technology, a visual technology (e.g., an image pattern recognition technology), etc. Also for example, the device includes an antenna to read the first tag information from the tag.

In step 602, the device obtains second tag information by performing, using a preset digital logic circuit in the device, a logical operation on the first tag information, the second tag information being real information of the tag.

In step 603, the device outputs the second tag information.

In exemplary embodiments, the first tag information in the tag is generated by, among other things, a digital logic circuit that matches the preset digital logic circuit in the device. For example, the digital logic circuit generating the first tag information is configured to perform a logical operation related to, e.g., the same as, the logical operation performed by the preset digital logic circuit in the device. As such, the first tag information is encrypted tag information, and the preset digital logic circuit in the device can perform a related logic calculation to decrypt the encrypted tag information.

One of ordinary skill in the art will understand that the above described modules can each be implemented by hardware, such as a circuit or a processor, or software, or a combination of hardware and software. One of ordinary skill in the art will also understand that multiple ones of the above described modules may be combined as one module, and each of the above described modules may be further divided into a plurality of sub-modules.

The operations performed by any of the above described tag reading apparatuses may be performed by one or more programmable processors executing one or more computer programs. The operations performed by any of the above described tag reading apparatuses may also be performed by logic circuitry, e.g., a field programmable gate array (FPGA) or an application specific integrated circuit (ASIC).

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. Apparatus for reading a tag, comprising:
a reading module for reading first tag information from the tag;
a digital logic control module coupled to the reading module, the digital logic control module including a preset digital logic circuit for performing a logical operation on the first tag information to obtain second tag information, the second tag information including real information of the tag; and
an output module coupled to the digital logic control module for outputting the second tag information.

2. The apparatus of claim 1, further comprising:
a tag database for storing tag information of multiple tags that the apparatus is capable of identifying; and
a tag identification module for identifying the second tag information outputted by the output module in the tag database.

3. The apparatus of claim 2, wherein the tag database stores state response values of a plurality of tags, each state response value indicating a state of one corresponding item, the apparatus further comprising:
an update module for, when the tag identification module identifies the second tag information, and the tag database stores a state response value of the tag corresponding to the second tag information, updating the state response value of the tag in accordance with a current state of the item corresponding to the tag.

4. The apparatus of claim 1, further comprising:
a communication interface coupled to the output module, for receiving the second tag information from the output module and sending the received second tag information to user equipment.

5. The apparatus of claim 4, wherein
the communication interface is configured to connect to a headset jack of the user equipment.

6. The apparatus of claim 1, wherein the output module comprises:
an audio output converter for converting the second tag information into an audio signal; and
a speaker for outputting the converted audio signal to user equipment, for the user equipment to identify the second tag information after converting the audio signal back into the second tag information.

7. The apparatus of claim 6, further comprising:
a microphone for receiving an audio signal from the user equipment; and
an audio input converter for converting the received audio signal into a digital signal for processing.

8. The apparatus of claim 7, wherein
the digital logical control module performs a logic operation on the digital signal converted by the audio input conversion module.

9. The apparatus of claim 4, further comprising:
an update module for, when the second tag information is identified in the user equipment and a state response value of the tag corresponding to the second tag information is stored in the user equipment, updating the state response value of the tag in accordance with a current state of an item corresponding to the tag.

10. The apparatus of claim 4, further comprising:
an update module for, when the second tag information is identified on the user equipment and a state response value of the tag corresponding to the second tag information is stored on a remote server, updating the state response value of the tag in accordance with a current state of an item corresponding to the tag through the user equipment.

11. The apparatus of claim 1, further comprising:
a pairing interface for connecting the apparatus with a paired device to share data with the paired device, wherein a digital logic control module of the paired device matches the digital logic control module of the apparatus.

12. The apparatus of claim 1, wherein the reading module is configured to read the first tag information based on at least one of:
a radio-frequency identification (RFID) technology, a near field communication (NFC) technology, a Bluetooth technology, or a Wi-Fi technology.

13. A tag identification system, comprising:
a tag including first tag information, the first tag information being generated by a first digital logic circuit; and
a tag reading apparatus, wherein the tag reading apparatus includes:
a reading module for reading the first tag information from the tag;
a digital logic control module coupled to the reading module, the digital logic control module including a preset digital logic circuit matching the first digital logic circuit for performing a logical operation on the first tag information, to obtain second tag information, the second tag information including real information of the tag; and
an output module coupled to the digital logic control module for outputting the second tag information.

14. A method for a device to read a tag, comprising:
reading first tag information from the tag;
performing, by a preset digital logic circuit in the device, a logical operation on the first tag information to obtain second tag information, the second tag information including real information of the tag; and
outputting the second tag information.

15. The method of claim 14, further comprising:
storing tag information of multiple tags that the device is capable of identifying; and
identifying the second tag information in the tag database.

16. The method of claim 15, wherein the tag database stores state response values of a plurality of tags, each state response value indicating a state of one corresponding item, the method further comprising:
updating, when the second tag information is identified in the database, and the tag database stores a state response value of the tag corresponding to the second tag information, the state response value of the tag in accordance with a current state of the item corresponding to the tag.

17. The method of claim 14, further comprising:
sending the second tag information to user equipment.

18. The method of claim 14, further comprising:
converting the second tag information into an audio signal; and
outputting the converted audio signal to user equipment, for the user equipment to identify the second tag information.

19. The method of claim 14, further comprising:
receiving an ultrasonic signal from user equipment; and
converting the ultrasonic signal into a digital signal for processing.

20. The method of claim 14, further comprising:
receiving an audio signal from user equipment; and
converting the audio signal into a digital signal for processing.

21. The method of claim 14, wherein the reading of the first tag information comprises:
reading the first tag information based on an image pattern recognition technology.
